(19) United States
(12) Patent Application Publication
(10) Pub. No.: US 2007/0239562 A1
(43) Pub. Date: Oct. 11, 2007

(54) METHOD FOR NOTIFYING A USER OF A LIVE EVENT

(76) Inventor: Jeffrey G. Lawson, Seattle, WA (US)

Correspondence Address: SCHOX PLC, 209 N. MAIN STREET #200, ANN ARBOR, MI, 48104, US

(21) Appl. No.: 11/690,082

(22) Filed: Mar. 22, 2007

Related U.S. Application Data
(60) Provisional application No. 60/784,974, filed on Mar. 22, 2006.

(51) Int. Cl. G06Q 30/00

(52) U.S. Cl. 705/26

(57) ABSTRACT

The preferred embodiment of the invention includes a method for notifying a user of a live event. The method includes the following steps: (a) analyzing data related to media associated with different performers within a user's collection or usage history; (b) deducing a performer preferred by the user based on the analysis; (c) receiving data related to a location from the user; (d) determining a live event associated with the preferred performer and located near the received location; and (e) notifying the user of the live event. The method of the preferred embodiment is preferably incorporated into an online media store that provides media associated with particular performers (such as songs, audiobooks, podcasts, music videos, short films, TV shows, sporting events, and movies). Because the online media store offers the media content, they are in a “trusted” position to offer other services, such as the notification of live events.

### CROSS-REFERENCE TO RELATED APPLICATIONS

This application claims the benefit of U.S. Provisional Application No. 60/784,974 entitled “Method for Notifying a User of a Live Event” and filed on 22 Mar. 2006, which is incorporated in its entirety by this reference.

### BRIEF DESCRIPTION OF THE FIGURE

FIG. 1 is a flowchart of the method for notifying a user of a live event according to a preferred embodiment of the invention.

### DESCRIPTION OF THE PREFERRED EMBODIMENT

The following description of the preferred embodiment of the invention is not intended to limit the invention to this preferred embodiment, but rather to enable any person skilled in the art to make and use this invention.

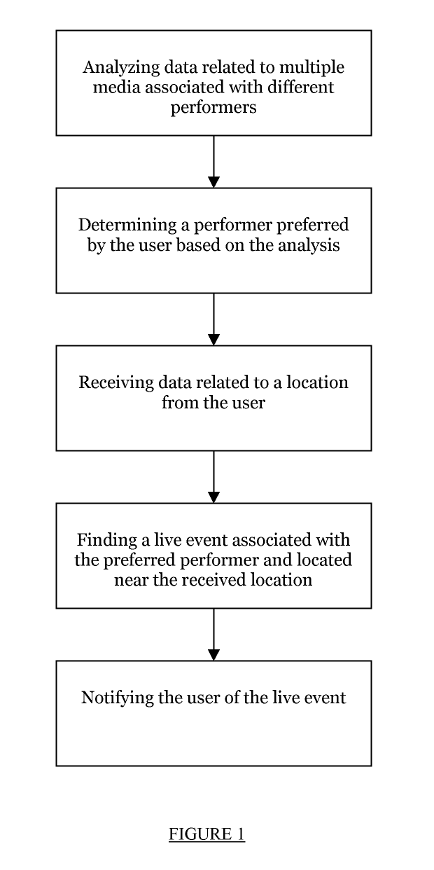

As shown in FIG. 1, the preferred embodiment of the invention includes a method for notifying a user of a live event. The method includes the following steps: (a) analyzing data related to media associated with different performers within a user's collection or usage history; (b) deducing a performer preferred by the user based on the analysis; (c) receiving data related to a location from the user; (d) determining a live event associated with the preferred performer and located near the received location; and (e) notifying the user of the live event.

The method of the preferred embodiment is preferably incorporated into an online media store, such as the Apple iTunes Store, that provides media associated with particular performers (such as songs, audiobooks, podcasts, music videos, short films, TV shows, sporting events, and movies). The online media service are in a “trusted” position to offer other services, such as the notification of live events, because they offer the media content. The method may alternatively be incorporated into any suitable online establishment (e.g., an informational website like Google.com), any suitable brick-and-mortar establishment (e.g., a media-related store like Record Time in Ferndale, Mich.), or any suitable device (e.g., a mobile phone, an iPod, set-top box, or any similar multi-media device that can access a database or receive electronic communications).

The first and second steps of the preferred method, which include analyzing data related to multiple media associated with different performers within a user's collection and deducing a performer preferred by the user based on the analysis, functions to automatically deduce the preferred performer(s) of the user. The media is preferably associated with one or more particular performers. As examples, the song “Wreck of the Edmund Fitzgerald” is associated with musician Gordon Lightfoot, the sporting event “NFL Super Bowl XL” is associated with the athletes of the Pittsburgh Steelers and the Seattle Seahawks, the TV show “Arrested Development” is associated with the actor Jason Bateman and the comedian David Cross, and the movie “Barton Fink” is associated with actors John Turturro and John Goodman, and the writers/directors Joel Coen and Ethan Coen. The media may be recorded media or may be “live” media that is broadcasted, streamed, or otherwise transmitted to the user. The media is preferably located in a “collection” of the user. The collection is linked with the media that has been downloaded, purchased, rented, leased, marked, tagged, or otherwise associated with a particular user. The collection is preferably stored in a physical location (such as purchased media on the memory of a device owned and operated by the user, or on the memory of a server owned and operated by a third party but accessible by the user). The collection may, however, be stored in a virtual location (such as marked or tagged media within a larger subscription-based model). The user's collection preferably includes data (also known as meta data) related to the media. This meta data preferably includes title, performer(s), category, genre, date added, last played, play count, skip count, user-generated taxonomic tags, and rating, but may alternatively include other suitable data related to the media and/or related to the use of the media by the user.

The analysis of the data related to the media and the deduction of the preferred performer includes comparing data of multiple media. The comparison of the data includes the following measurements and calculations for all media of a particular performer: (1) total play count, (2) average of the play count divided by the number of days between the current date and the date added, (3) total play count divided by the total play count of all media in same genre or category, (4) date last played, (5) average rating by the user, (6) total number of songs or albums associated with a particular performer in the user's collection, (7) total number of songs or albums associated with a particular performer that is available to the user, (8) recent additions to the user's collection, (9) skip count or (10) a weighted combination of one or more of these user parameters. The analysis may, however, include any suitable measurements and/or calculations. Based on the comparison of the data of the media, a preferred performer is deduced. The first and second steps may deduce one or more preferred performers. The number of preferred performers is preferably a pre-defined number (such as 20), but may alternatively be a user-defined number or a variable number based on any suitable factor (such as total number of performers in the user's collection, or the desired quantity of correspondences with the user), or may be a preference value on which to sort the full list.

The third and fourth steps of the preferred method, which includes receiving data related to a location from the user and determining a live event associated with the preferred performer and located near the received location, functions to narrow the number of live events associated with the preferred performer. The data related to a location from the user preferably includes an explicitly given postal address for the residence of the user, but may alternatively include a geographical region (such as a zip code, county, or state). Furthermore, the data may be inferred, such as from the contemporaneous GPS coordinates of the user from a mobile phone or other suitable digital device, from the location of an installed set-top box or computer, from the network address of a computer, or from the physical presence of a user in a known location (such as a retail store). The postal address, the geographical region, or the GPS coordinates may be current location for the user, or may be an anticipated future location of the user as specified through an input from the user or through an automatic ping from a calendar or another suitable device or application.

The determination of a live event is based on the data related to the location and includes searching live events that (1) are associated with the preferred performers, and (2) are located within a region that is defined by the area that is reasonably accessible to the user. The live event is preferably any event associated with a performer and a location, such as a concert, a sporting event, a speaking engagement, a theater event, or any other suitable performance or event. The first factor is a fairly simple search, but may include slightly more complicated abstractions that expand the scope of “performer” to include other entities (such as searching for both the band Guided By Voices and the lead singer/guitarist Robert Pollard when Guided By Voices is the preferred performer). The searching is preferably accomplished through an application programming interface (API) that interfaces and exchanges data with a database of a partner, through a data scraping program that scrapes data of a third-party website (such as www.TicketMaster.com), or through a search program that searches data of an internal database (such as an SQL database). The searching may, however, be accomplished with any suitable method or device. The second factor is preferably a calculation based on a pre-defined number mile radius (such as 15 miles), but may alternatively be a user-defined number or a variable number based on any suitable factor (such as estimated driving time or availability of public transportation). The second factor may also be a variable number based on the “preference level” of the performer. For example, the second factor may include a pre-defined mile radius of 100 miles for the most preferred performer, and a pre-defined radius of 10 miles for the least preferred performer. In another variation, the determination of a live event may be based on a combination of a “preference level” and an “event proximity” for one or more of the performers. The “preference level” corresponds to the preference of the performer by the user, while the “event proximity” corresponds to the distance and/or travel time of a live event by the performer.

The fifth step includes notifying the user of the live event. The notification is preferably accomplished through a message system (such as an email, an SMS, a voice message, or an RSS feed) or through a display system (such as a webpage, a television display, or a desktop application known as a widget). The notification may be alternatively accomplished through any suitable device or method, including the “upselling” by a live retail employee. The first step may be followed by a sixth step that includes facilitating a ticket purchase for the live event or facilitating more information about the live event. The facilitation of more information may provide a revenue stream for the promoter/seller of the live event, which may allow for a portion of the revenue stream to be shared with the entity that implements and operates the preferred method of the invention.

As a person skilled in the art will recognize from the previous detailed description and from the figures and claims, modifications and changes can be made to the preferred embodiment of the invention without departing from the scope of this invention defined in the following claims.

I claim:

1. A method for notifying a user of a live event, comprising:
analyzing data related to multiple media associated with different performers;
determining a performer preferred by the user based on the analysis;
receiving data related to a location from the user;
finding a live event associated with the preferred performer and located near the received location; and
notifying the user of the live event.

2. The method of claim 1, wherein analyzing data includes analyzing data related to multiple media associated with different performers within a collection of the user.

3. The method of claim 2, wherein the collection is stored in a device owned and operated by the user.

4. The method of claim 2, wherein the collection is stored on a server owned and operated by a third party.

5. The method of claim 1, wherein determining a performer preferred by the user includes determining a preference value of the user for multiple performers based on the analysis.

6. The method of claim 5, wherein finding a live event associated with the preferred performer includes determining an event proximity for the multiple performers, wherein the event proximity corresponds to a distance between the received location and the live event.

7. The method of claim 1, wherein analyzing data includes analyzing one or more factors selected from the group consisting of performer, date added, last played, play count, and rating.

8. The method of claim 7, wherein analyzing data further includes analyzing skip count.

9. The method of claim 1, wherein determining a performer preferred by the user includes (a) determining a value associated with the total play count of all media in a same genre or category and (b) determining a value associated with the play count of a media divided by the total play count of all media in the same genre or category.

10. The method of claim 1, wherein determining a performer preferred by the user includes determining a value associated with the play count divided by the number of days between the current date and the date added.

11. The method of claim 1, wherein determining a performer preferred by the user includes (a) determining a value associated with the total number of songs or albums associated with a particular performer in the collection of the user, and (b) determining the total number of songs or albums associated with a particular performer available to the user.

12. The method of claim 1, wherein receiving data related to a location from the user includes receiving data related to a physical address for the residence of the user.

13. The method of claim 1, wherein receiving data related to a located from the user includes receiving data associated with the contemporaneous physical coordinates of a digital device of the user.

14. The method of claim 1, wherein finding a live event, includes finding a live event located within a pre-defined region of the received location.

15. The method of claim 14, wherein the pre-defined region is measured by one or more of the parameters selected from the group consisting of distance, driving distance, estimated driving time.

16. The method of claim 14, wherein determining a performer preferred by the user based on the analysis includes determining a first performer and a second performer preferred by the user, wherein the first performer is preferred more than the second performer, wherein the pre-defined region is larger for the first performer than the pre-defined region for the second performer.

17. The method of claim 1, wherein notifying the user of the live event includes notifying the user of the live event via one or more of the message systems selected from the group consisting of email, SMS, and voice message.

18. The method of claim 1, wherein notifying the user of the live event includes notifying the user of the live event via one or more of the display systems selected from the group consisting of a webpage, a television display, and a desktop widget.

19. The method of claim 1, further comprising facilitating a ticket purchase for the live event.

20. A computer program product that, when executed by a machine, notifies a user of a live event, comprising:
instructions to analyze data related to multiple media associated with different performers;
instructions to determine a performer preferred by the user based on the analysis;
instructions to receive data related to a location from the user;
instructions to find a live event associated with the preferred performer and located near the received location; and
instructions to notify the user of the live event.
